(19) United States
(12) Patent Application Publication
(10) Pub. No.: US 2020/0241710 A1
(43) Pub. Date: Jul. 30, 2020

(54) DISPLAY METHOD AND DISPLAY APPARATUS

(71) Applicant: Seiko Epson Corporation, Tokyo (JP)

(72) Inventor: Yusuke YAMADA, Shiojiri (JP)

(21) Appl. No.: 16/774,156

(22) Filed: Jan. 28, 2020

(30) Foreign Application Priority Data
Jan. 29, 2019 (JP) 2019-012827

(51) Int. Cl. G06F 3/0482; G06F 3/0481; G06F 3/0484

(52) U.S. Cl. CPC G06F 3/0482; G06F 3/04842; G06F 3/04817

(57) ABSTRACT

Provided is a display method in which each of a plurality of thumbnail images T arranged on a first virtual rotation axis Q is displayed on a display unit by being rotated about each of second virtual rotation axes M intersecting the first virtual rotation axis Q, and further rotated about the first virtual rotation axis Q, in which an thumbnail image bundle G formed by the plurality of thumbnail images T has a static portion in which the thumbnail images T are arranged at equal intervals in a state where a part of the thumbnail image T is displayed by being overlapped with an adjacent image, and a dynamic portion in which an interval between the thumbnail images T adjacent to each other is arranged wider than an interval between the thumbnail images T in the static portion, the thumbnail image T displayed in the dynamic portion is movable to the static portion, and a rotation angle θ of the thumbnail image T in the dynamic portion about the second virtual rotation axis M becomes smaller as the thumbnail image T in the dynamic portion is closer to a predetermined position K.

The present application is based on, and claims priority from, JP Application Serial Number 2019-012827, filed Jan. 29, 2019, the disclosure of which is hereby incorporated by reference herein in its entirety.

### BACKGROUND

### 1. Technical Field

The present disclosure relates to a display method and a display apparatus.

### 2. Related Art

In the related art, there has been disclosed an image processing apparatus that can display a list of a predetermined number of reduced images of images read by scanning a plurality of documents and the like and check the content of the read images (for example, see JP-A-2008-301502).

However, in the display method described in JP-A-2008-301502, when the number of reduced images to be displayed in a list exceeds a predetermined number, there is a problem that it is difficult to check the description contents of all the images at once because the reduced images are displayed more reduced, or a plurality of reduced images are displayed in an overlapped manner.

### SUMMARY

A display method according to an aspect of the present disclosure is a display method in which each of a plurality of images arranged on a first virtual axis is displayed on a display unit by being rotated about each of second virtual axes intersecting the first virtual axis, and further rotated about the first virtual axis, an image bundle formed by the plurality of images that are arranged along a first direction has a static portion in which the images are arranged at equal intervals in a state where apart of the image is displayed by being overlapped with an adjacent image, and a dynamic portion in which an interval between the images adjacent to each other is arranged wider than an interval between the images in the static portion, the image displayed in the dynamic portion is movable to the static portion, and a rotation angle of the image in the dynamic portion about the second virtual axis along a second direction intersecting the first direction becomes smaller as the image in the dynamic portion is closer to a predetermined position.

In the display method described above, the predetermined position may be a center of the dynamic portion in the first direction.

In the display method described above, when the image bundle is moved in the second direction, the image bundle may be enlarged and displayed at a predetermined enlargement ratio.

In the display method described above, when the number of the plurality of images in the dynamic portion is less than a predetermined number of images, the plurality of images in the dynamic portion may be displayed with the rotation angles smaller than the case of the predetermined number of images.

In the display method described above, when the number of images, in which a length in the first direction is longer as compared with a length in the second direction, is greater than the number of images, in which the length in the first direction is shorter as compared with the length in the second direction in the dynamic portion, the plurality of images in the dynamic portion may be displayed with the number of images in the dynamic portion reduced as compared with a case where the number of images, in which the length in the first direction is shorter as compared with the length in the second direction, is greater than the number of images, in which the length in the first direction is longer as compared with the length in the second direction.

In the display method described above, when a part of the image bundle is not displayed, either one of end portions among the both end portions, that face each other in the second direction, of each of the plurality of images constituting the image bundle, may be aligned and displayed.

In the display method described above, an interval between an operation image, in which a predetermined operation is performed in the image bundle, and the adjacent image may be displayed wider than before the predetermined operation.

In the display method described above, when an operation image, in which a predetermined operation is performed in the image bundle, is arranged in the dynamic portion, the images adjacent to each other may be displayed so as not to overlap with each other.

A display apparatus according to another aspect of the present disclosure includes: a display unit that displays an image bundle formed by a plurality of images arranged along a first direction; an image generation unit that generates the plurality of images in which each of the plurality of images arranged on a first virtual axis along the first direction are rotated about each of the second virtual axes intersecting the first virtual axis, and further rotated about the first virtual axis; and a control unit that displays the image bundle having a static portion in which the images are arranged at equal intervals in a state where a part of the image is displayed by being overlapped with an adjacent image, and a dynamic portion in which an interval between the images adjacent to each other is arranged wider than an interval between the images in the static portion, and displays the image in the dynamic portion such that the image in the dynamic portion closer to a predetermined position has a smaller rotation angle about the second virtual axis along a second direction intersecting the first direction.

### BRIEF DESCRIPTION OF THE DRAWINGS

FIG. 1 is a diagram showing an appearance of a viewer according to an embodiment.

FIG. 2 is a diagram showing a thumbnail image bundle displayed on an image display unit and a thumbnail image that is enlarged and displayed.

FIG. 3 is a block diagram showing a system configuration of a viewer.

FIG. 4 is a block diagram showing a system configuration of the viewer.

FIG. 5 is a flowchart showing an example of processing of the viewer.

FIG. 6 is a flowchart showing an example of processing of the viewer.

FIG. 7 is a flowchart showing an example of processing of the viewer.

FIG. 8 is a diagram for explaining determination processing of a rotation angle.

FIG. 9A is a diagram for explaining generation processing of a thumbnail image.

FIG. 9B is a diagram for explaining the generation processing of the thumbnail image.

FIG. 9C is a diagram for explaining the generation processing of the thumbnail image.

FIG. 9D is a diagram for explaining the generation processing of the thumbnail image.

FIG. 9E is a diagram for explaining the generation processing of the thumbnail image.

FIG. 10A is a diagram for explaining an arrangement method of the thumbnail image.

FIG. 10B is a diagram for explaining an arrangement method of the thumbnail image.

FIG. 10C is a diagram for explaining an arrangement method of the thumbnail image.

FIG. 11 is a flowchart showing an example of processing of the viewer.

FIG. 12 is a diagram for explaining a spread.

FIG. 13 is a flowchart showing an example of processing of the viewer.

FIG. 14 is a diagram for explaining an arrangement method in which a spread is positioned in a dynamic portion.

FIG. 15 is a flowchart showing an example of processing of the viewer.

FIG. 16 is a diagram in which a thumbnail image bundle is enlarged and displayed.

FIG. 17 is a diagram in which a thumbnail image bundle, where the number of images in the dynamic portion is less than a predetermined number of images, is displayed.

FIG. 18 is a diagram in which a thumbnail image bundle, where the number of images in the dynamic portion is less than a predetermined number of images, is displayed.

FIG. 19 is a diagram in which a thumbnail image bundle, where a vertically long image and a horizontally long image are mixed, is displayed.

FIG. 20 is a diagram in which a thumbnail image bundle where a vertically long image and a horizontally long image are mixed, and an end portion of each thumbnail image is aligned and displayed.

FIG. 21 is a diagram in which an interval between an operating thumbnail image and an adjacent thumbnail image is widened and displayed.

FIG. 22 is a diagram in which an operating thumbnail image and an adjacent thumbnail image are displayed so as not to overlap with each other.

FIG. 23 is a diagram for explaining a method of moving and displaying a thumbnail image in the dynamic portion to the static portion.

FIG. 24 is a diagram in which a thumbnail image in the dynamic portion is moved to the static portion and displayed.

FIG. 25 is a diagram for explaining a method for reducing and displaying a width of a thumbnail image bundle.

FIG. 26 is a diagram for explaining a method for reducing and displaying a width of a thumbnail image bundle.

### DESCRIPTION OF EXEMPLARY EMBODIMENTS

### Embodiment

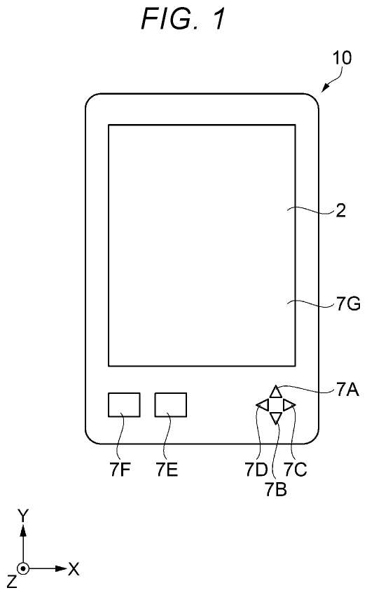

Hereinafter, a display method and a display apparatus according to the present embodiment will be described with reference to the drawings. In the present embodiment, an explanation will be given by taking as an example a viewer that can browse and edit an electronic manual, an electronic book, or a document created by a user, which is an example of a document including images, as a display apparatus. In the drawings referred to in the following description, the vertical and horizontal scales of members or portions may be expressed differently from actual ones for convenience of explanation and illustration. In addition, illustrations of components other than those necessary for the explanation maybe omitted. In the following, for convenience of explanation, FIGS. 1, 2, 16, 17, 18, 19, 20, 21, and 22 show an X axis, a Y axis, and a Z axis as three axes orthogonal to each other, and a tip side of an arrow indicating each axis is “+”, and a proximal side is “−”. Further, the direction along the X axis is referred to as a “horizontal direction” as a first direction, the direction along the Y axis is referred to as a “vertical direction” as a second direction, and the direction along a Z axis is referred to as a “depth direction”. The description will be made with the −X direction in the horizontal direction as a left or a left side and the +X direction as a right or a right side, and the −Y direction in the vertical direction as a bottom or a bottom side and the +Y direction as a top or a top side. In the present embodiment, the first direction is the horizontal direction and the second direction is the vertical direction. However, the first direction may be the vertical direction and the second direction may be the horizontal direction. That is, the first direction and the second direction only need to intersect each other.

### Overview of Viewer

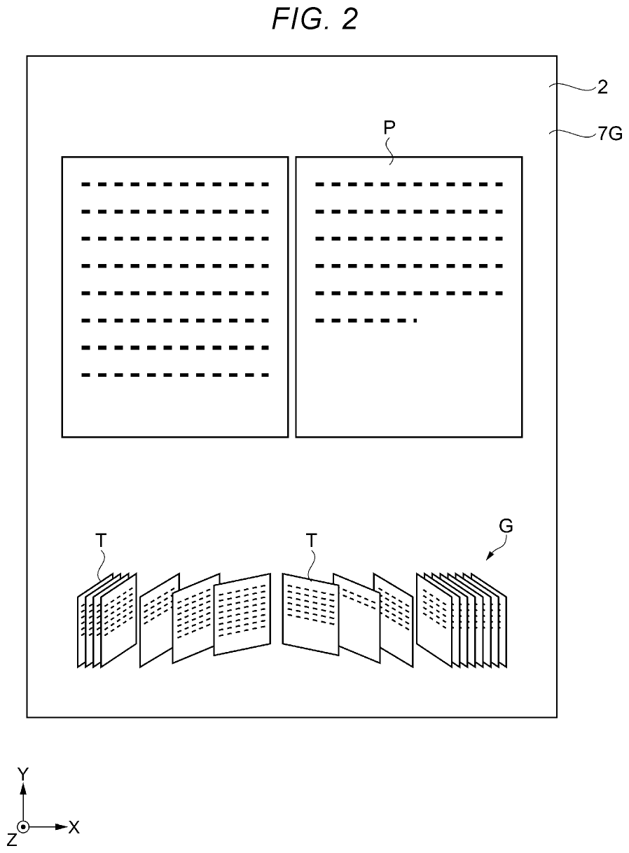

First, an overview of a viewer 10 according to an embodiment will be described with reference to FIGS. 1 and 2.

FIG. 1 is a diagram showing an appearance of a viewer according to the present embodiment, and is a front view of the viewer 10 viewed from an image display unit 2 side as a display unit. FIG. 2 is a diagram showing a thumbnail image bundle G formed by a plurality of thumbnail images T displayed on the image display unit 2 and a thumbnail image P that is enlarged and displayed.

The viewer 10 according to the present embodiment is a display apparatus that displays an image. In this example, the viewer 10 is an apparatus for browsing an electronic book as an example of a document, a so-called electronic book reader. An electronic book is document data including images of a plurality of pages. The viewer 10 displays an electronic book on the image display unit 2 in a certain unit. The certain unit is, for example, one page at a time. Among a plurality of pages included in an electronic book, a page to be displayed is called a selection page. The selection page is changed according to the operation of buttons 7A to 7F or a touch panel 7G shown in FIG. 1 by a user. That is, the user can turn the pages of the electronic book by operating the buttons 7A to 7F or the touch panel 7G. The viewer 10 has a function of executing an application program in addition to browsing electronic books.

As shown in FIG. 2, the image display unit 2 according to the present embodiment displays a thumbnail image T as an image obtained by reducing each page of an electronic manual, an electronic book, or a document created by a user, and an original image P of the selected thumbnail image T. The image display unit 2 displays a thumbnail image bundle G as an image bundle in which a plurality of thumbnail images T are arranged in the horizontal direction.

The thumbnail image bundle G is arranged along the lower side of the image display unit 2 in the lower portion, which is the lower side of the image display unit 2 in the vertical direction, and the lower end of the thumbnail image bundle G may extend outside the display area of the image display unit 2.

The thumbnail image T is an image having a size that occupies a part of the image display unit 2 and is an image obtained by reducing or enlarging the original image. The original image is an image of each page of an electronic manual, an electronic book, or document data created by a user. The original image may be an icon of an application program or an operation screen of an application program. An application program and its operation may be assigned to each of the plurality of thumbnail images T.

The viewer 10 includes the buttons 7A to 7F and the touch panel 7G as an input unit 7 on a surface on which the image display unit 2 is disposed. The input unit 7 takes in an input from the outside. The input unit 7 receives an operation from a user and processes the operation as an input signal. That is, the user operates the input unit 7 to perform a predetermined input on the viewer 10.

### System Configuration of Viewer

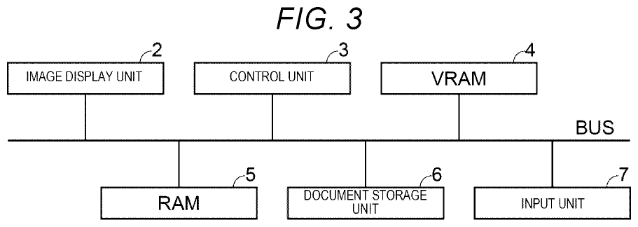

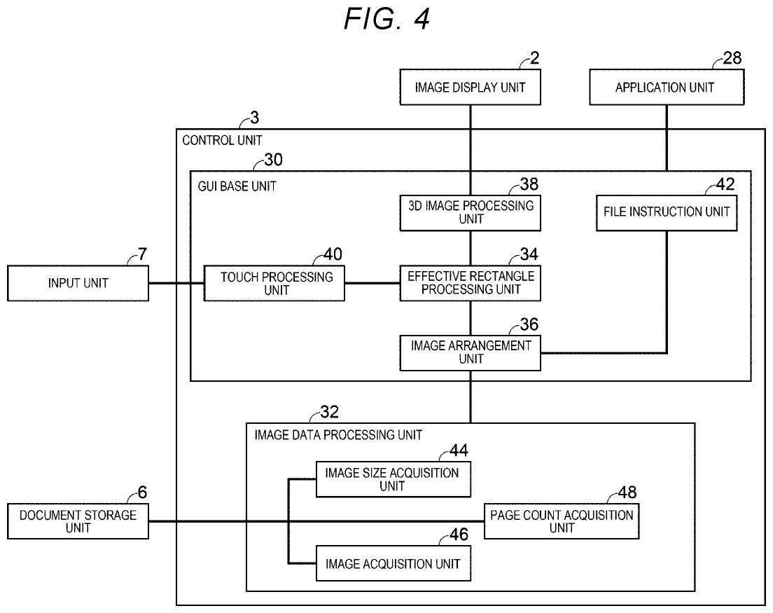

Next, the system configuration of the viewer 10 will be described with reference to FIGS. 3 and 4.

FIGS. 3 and 4 are block diagrams showing a system configuration of the viewer 10.

As shown in FIG. 3, the viewer 10 includes the image display unit 2 coupled to a bus BUS, a control unit 3, a video random access memory (VRAM) 4, a random access memory (RAM) 5, a document storage unit 6, and the input unit 7. Signals or information between the units coupled to the bus BUS are transferred via the bus BUS.

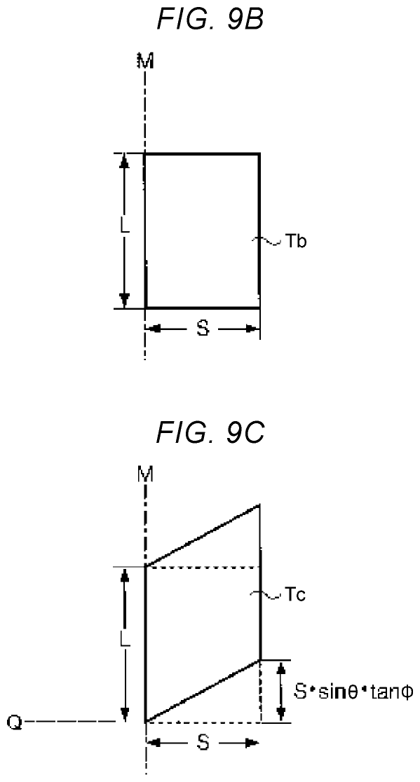

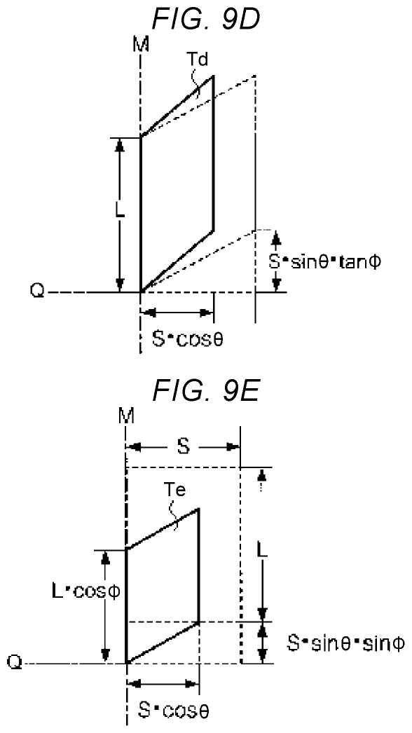

The image display unit 2 displays a thumbnail image T corresponding to an original image and the original image P of the thumbnail image T. The image display unit 2 displays the thumbnail image bundle G in which the plurality of thumbnail images T are arranged in the horizontal direction. The image display unit 2 displays the plurality of thumbnail images T in a state where the thumbnail image bundle G is viewed from above. As shown in FIG. 9E, which will be described later, the image display unit 2 displays a bird's-eye view image that is an image obtained by viewing the thumbnail image bundle G arranged in a virtual space from any viewpoint in the virtual space including a first virtual rotation axis Q as a first virtual axis and a second virtual rotation axis M as a second virtual axis.

The image display unit 2 includes a display drive circuit (not shown) that outputs a signal for displaying an image on a liquid crystal panel or the like. The image display unit 2 displays image data stored in the VRAM 4 as an image.

The control unit 3 is a device that controls each unit of the viewer 10, for example, is a microcomputer having a central processing unit (CPU), a read only memory (ROM), or the like. The CPU executes a program stored in the ROM or RAM 5 using the RAM 5 as a work area. The ROM stores, for example, an operating system (OS) program for controlling basic operations of the viewer 10.

The control unit 3 controls each unit of the viewer 10 based on the program stored in the ROM. For example, the control unit 3 performs control to store various image data in the VRAM 4, and performs control to operate the viewer 10 based on the operated buttons 7A to 7F, the touch panel 7G, or the content by specifying the buttons 7A to 7F, the touch panel 7G, or the content operated by a user from the input signal sent from the input unit 7. Further, the control unit 3 controls image processing with respect to the image displayed on the image display unit 2. As the image processing, for example, processing of an enlargement display of the selection page or a highlight display for the thumbnail image T is performed.

The VRAM 4 is a memory that stores image data indicating an image to be displayed on the image display unit 2. The VRAM 4 is a memory that stores the developed image data. The image data stored in the VRAM 4 is displayed on the image display unit 2.

The RAM 5 is a memory in which the content of the image processing executed by the control unit 3 and the association with the image data are stored.

A document storage unit 6 is a rewritable memory, and stores document data such as an electronic manual, an electronic book, or a document created by a user. The document storage unit 6 can store a plurality of different document data and can appropriately rewrite the document data. The document storage unit 6 is a non-volatile memory that stores various data and application programs in addition to the document data. The document storage unit 6 may be, for example, a semiconductor memory built in the viewer 10 or a removable external memory such as an SD memory card.

The input unit 7 includes the buttons 7A to 7F shown in FIG. 1. When the buttons 7A to 7F are operated, the input unit 7 transmits the input signal corresponding to the operated button to the control unit 3. The input unit 7 includes the touch panel 7G.

As shown in FIG. 4, the control unit 3 includes a GUI base unit 30 as an image generation unit and an image data processing unit 32.

The GUI base unit 30 causes each of the plurality of thumbnail images T arranged on the first virtual rotation axis Q to rotate about each second virtual rotation axis M intersecting the first virtual rotation axis Q and further to rotate about the first virtual rotation axis Q, and then generates the thumbnail images T. The GUI base unit 30 generates a bird's-eye view image that is an image of the thumbnail image bundle G arranged in the virtual space from any viewpoint in the virtual space.

The GUI base unit 30 includes an effective rectangle processing unit 34, an image arrangement unit 36, a 3D image processing unit 38, a touch processing unit 40, and a file instruction unit 42.

The effective rectangle processing unit 34 sets a thumbnail image display area as an occupied area.

The image arrangement unit 36 determines a rotation angle θ of the thumbnail image T that rotates about the second virtual rotation axis M. Based on the determined rotation angle θ, the GUI base unit 30 generates a thumbnail image T.

The image arrangement unit 36 divides the thumbnail image bundle G formed by the plurality of thumbnail images T into the static portion, in which the thumbnail images T are arranged at equal intervals, in a state where a part of the thumbnail image T is displayed by being overlapped with an adjacent thumbnail image T and the dynamic portion, in which the interval between the thumbnail images T adjacent to each other is arranged wider than the interval between the thumbnail images Tin the static portion, and calculates a common standard page pitch of the static portion and the dynamic portion.

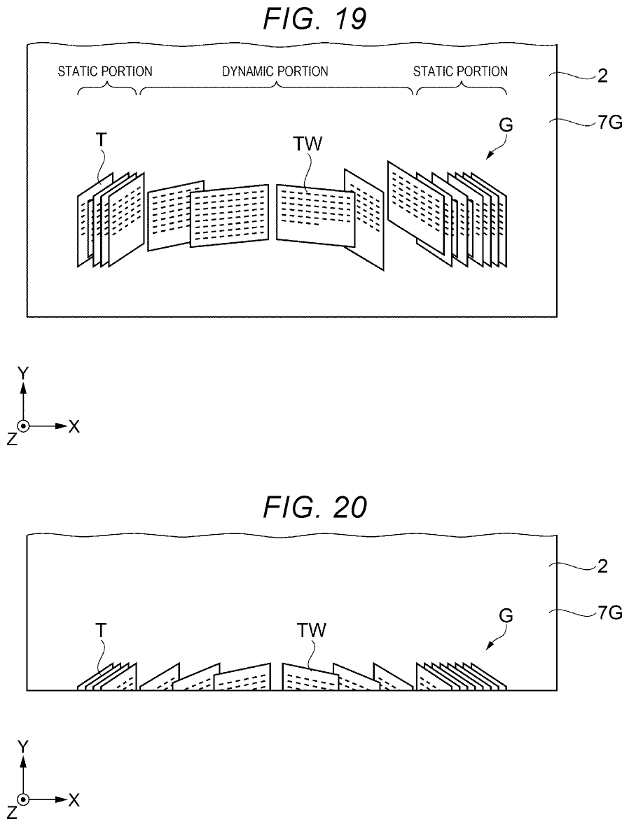

The image arrangement unit 36 calculates a width of the spread page and a width shared by the pages in the dynamic portion excluding the amount occupied by the standard page pitch and spread page width of each page from the entire image width. In addition, when a vertically long thumbnail image T and a horizontally long thumbnail image TW as shown in FIG. 19 are mixed in the dynamic portion of the thumbnail image bundle G, the number of pages in the dynamic portion is reduced, or the normal distribution applied to the arrangement of the dynamic portion is steep.

The image arrangement unit 36 performs the above-described calculation and determines arrangement positions of the plurality of thumbnail images T constituting the thumbnail image bundle G.

The 3D image processing unit 38 is, for example, a Frame Buffer or a GPU.

The touch processing unit 40 detects a user touch on the touch panel 7G. The touch processing unit 40 acquires a touch signal from the touch panel 7G.

The file instruction unit 42 instructs the image data processing unit 32 to read an original image of a document data page based on the data supplied from the touch processing unit 40. The file instruction unit 42 is, for example, an Android (registered trademark) function of an operating system for mobile devices.

The image data processing unit 32 is, for example, a PDF library.

The image data processing unit 32 includes an image size acquisition unit 44, an image acquisition unit 46, and a page count acquisition unit 48.

The image size acquisition unit 44 acquires a length of an original image of a document data page in a horizontal direction from the document storage unit 6. The image size acquisition unit 44 acquires a length of an original image of a document data page in a vertical direction from the document storage unit 6.

The image acquisition unit 46 acquires an original image of a document data page from the document storage unit 6.

The page count acquisition unit 48 acquires the number of pages of document data from the document storage unit 6.

An application unit 28 is application software such as printing software for photographs and documents, New Year's card printing software, or projection software for projecting photographs or documents or the like with a projector.

### Operation of Viewer

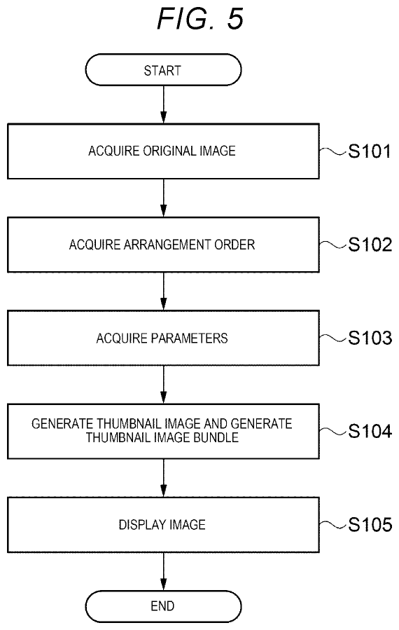

Next, the operation of the viewer will be described with reference to FIGS. 5 to 15.

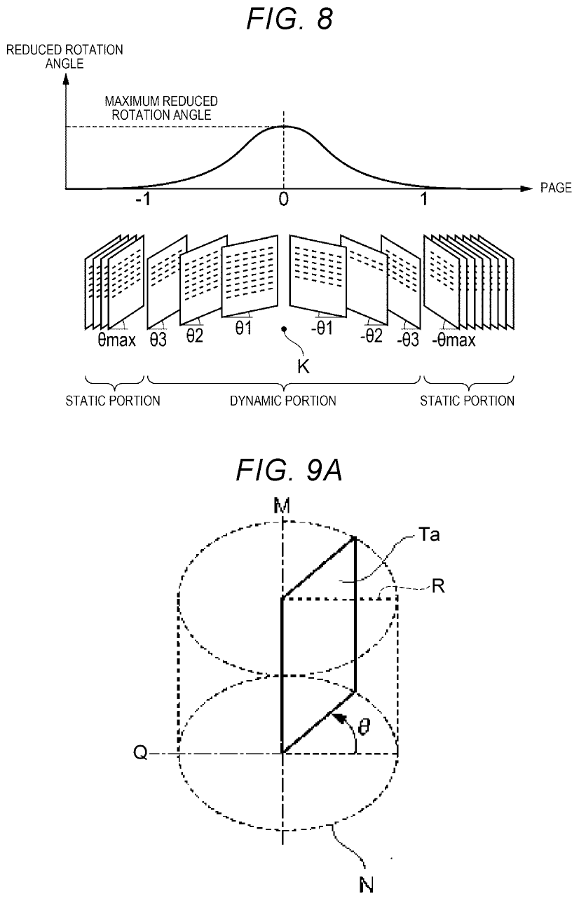

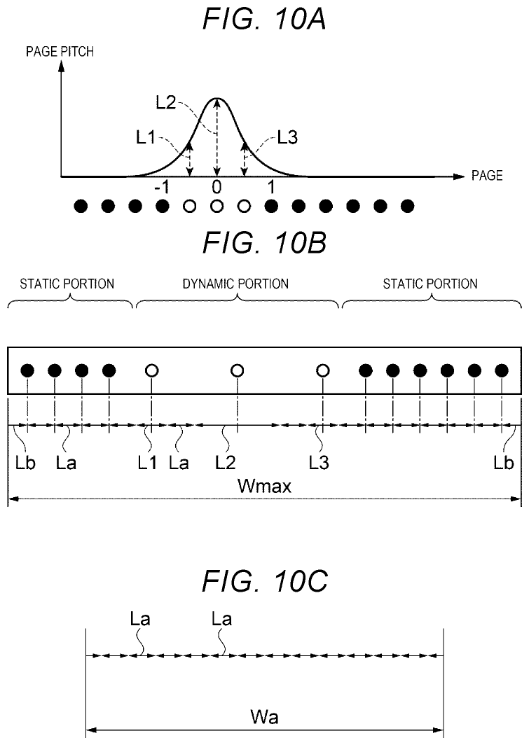

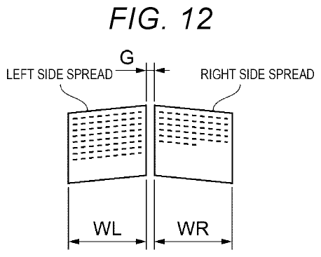

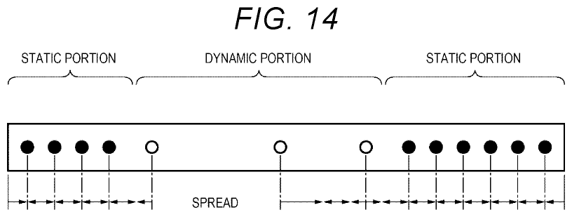

FIGS. 5, 6, 7, 11, 13, and 15 are flowcharts showing an example of processing of the viewer 10. FIG. 8 is a diagram for explaining determination processing of a rotation angle θ. FIGS. 9A to 9E are diagrams for explaining the generation processing of the thumbnail image. FIGS. 10A to 10C are diagrams for explaining an arrangement method of the thumbnail image. FIG. 12 is a diagram for explaining a spread. FIG. 14 is a diagram for explaining an arrangement method in which a spread is positioned in a dynamic portion. Hereinafter, the operation of the control unit 3 will be described with reference to FIG. 2 along the flowchart of FIG. 5.

The control unit 3 generates a thumbnail image bundle G in which the generated thumbnail images T are arranged in ascending order of page numbers from the right side to the left side of the image display unit 2.

The image arrangement unit 36 divides the thumbnail image bundle G into the static portion and the dynamic portion, calculates the arrangement position of the thumbnail image T in the static portion and the arrangement position of the thumbnail image T in the dynamic portion, and determines the arrangement positions of the plurality of thumbnail images T constituting the thumbnail image bundle G.

The flow in FIG. 5 is started when a predetermined event occurs, for example, when the viewer 10 is turned on or when the viewer 10 is instructed to display a menu screen, for example.

First, in step S101, a file instruction unit 42 instructs an image acquisition unit 46 to readout the original image specified by a user using the buttons 7A to 7F of the input unit 7 or the touch panel 7G from the document storage unit 6. The control unit 3 acquires the thumbnail image bundle G to be processed, in this example, the original images of the plurality of thumbnail images T included in the thumbnail image bundle G.

Next, instep S102, the control unit 3 acquires data indicating an arrangement order of the plurality of thumbnail images T. The data includes an identifier of the thumbnail image T and a number indicating the arrangement order.

The data includes a number indicating the arrangement order of the thumbnail image T and a file name as an identifier of the thumbnail image T. The data is stored in the document storage unit 6. In step S101, the control unit 3 reads out the data from the document storage unit 6, and acquires an original image having a file name included in the data from the document storage unit 6. In step S102, the control unit 3 acquires the arrangement order of the thumbnail image T from the data.

Next, in step S103, the control unit 3 acquires parameters used for displaying the thumbnail image bundle G. These parameters are stored in the document storage unit 6 together with the identifier of the thumbnail image bundle G. The parameters acquired here include the number of images and the width dimension of the images. The number of images is a parameter indicating the number of thumbnail images T included in the thumbnail image bundle G. The width dimension of the image is a parameter indicating the length of the thumbnail image bundle G in the horizontal direction.

Next, in step S104, the control unit 3 generates a thumbnail image bundle G using the thumbnail images T generated by the GUI base unit 30. Specifically, the control unit 3 reduces or enlarges the original image acquired by the GUI base unit 30 in step S101, and generates a thumbnail image bundle G using the generated thumbnail images T.

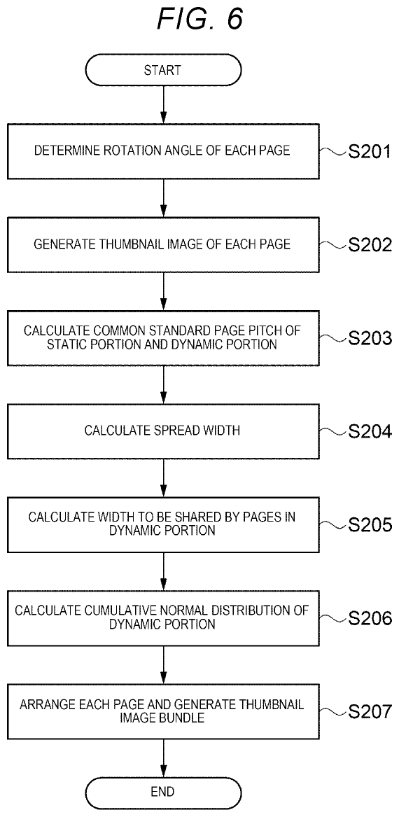

Hereinafter, an operation of generating the thumbnail images T and arranging the thumbnail images T to generate the thumbnail image bundle G by the control unit 3 will be described with reference to the flowchart in FIG. 6.

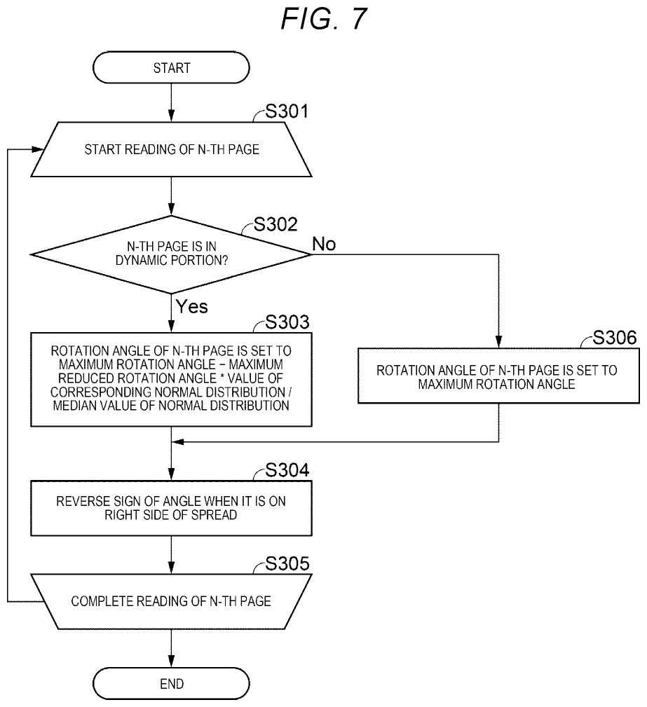

First, in step S201, the image arrangement unit 36 determines the rotation angle θ in which each page shown in FIG. 9A, which will be described later, rotates about the second virtual rotation axis M. This operation will be described with reference to the flowchart in FIG. 7.

First, in step S301, the image arrangement unit 36 starts reading the N-th page of the original image. N is an integer of 1 or more.

Next, in step S302, when the N-th page is not in the dynamic portion, “No” is determined and the process proceeds to step S306, then the image arrangement unit 36 sets a rotation angle θ of the N-th page to a maximum rotation angle θmax, and the process proceeds to step S304. When the N-th page is in the dynamic portion, “Yes” is determined and the process proceeds to step S303, and the rotation angle θ of the N-th page is set to “Maximum rotation angle−Maximum reduced rotation angle*Value of the corresponding normal distribution/Median value of the normal distribution”. As shown in FIG. 8, the rotation angle θ of the page arranged in the dynamic portion is calculated according to the normal distribution of the reduced rotation angle, and is reduced as the page is closer to a predetermined position K that is a center of the dynamic portion in the horizontal direction. The size correlation is as follows, the rotation angle θ1 of the page closest to the predetermined position K<the rotation angle θ2 of the page second closest to the predetermined position K<the rotation angle θ3 of the page third closest to the predetermined position K.

Next, in step S304, the image arrangement unit 36 reverses the sign of the angle when it is on the right side of the spread. That is, the rotation angles θ of the pages on the right side from the predetermined position K are set to −θ1, −θ2, −θ3, and −θmax.

Next, in step S305, the process returns to step S301, the operations from step S301 to step S305 are repeated for the number of pages, and the image arrangement unit 36 completes the reading of the N-th page and ends setting the rotation angle θ of each page.

Returning to FIG. 6, in step S202, the control unit 3 generates a thumbnail image T of each page. Specifically, in the GUI base unit 30, each of the plurality of thumbnail images T arranged on the first virtual rotation axis Q rotates about each second virtual rotation axis M intersecting the first virtual rotation axis Q and further rotate about the first virtual rotation axis Q, and then the thumbnail images T are generated.

As shown in FIG. 9A, the GUI base unit 30 arranges a page Ta so as to stand on the first virtual rotation axis Q set on a virtual horizontal plane N in the virtual space. Thereafter, with each second virtual rotation axis M intersecting the first virtual rotation axis Q as the center, the GUI base unit 30 rotates the page Ta from a reference position R in which the horizontal direction of the page Ta is parallel to the horizontal direction of the display area at the rotation angle θ. Furthermore, the GUI base unit 30 generates an image obtained by rotating the page Ta, which is rotated about each second virtual rotation axis M in the virtual space, about the first virtual rotation axis Q at a depression angle φ (not shown). That is, the GUI base unit 30 generates an image in which the page Ta is obliquely looked down at the depression angle φ (not shown) from a viewpoint above the upper side of the page Ta rotated about the second virtual rotation axis M in the virtual space. In other words, each thumbnail image is generated as an image in which the page Ta is obliquely viewed at the depression angle φ (not shown) and viewed in a bird's-eye view from the viewpoint above the upper side of page Ta in the virtual space. When the page is not rotated, the horizontal direction of the page is parallel to the horizontal direction of the display area, and the rotation angle θ is 0°. The depression angle φ is a predetermined angle. Further, the second virtual rotation axis M is not limited to a configuration that is parallel along the side in the second direction, which is the vertical direction of the page, and may be a configuration that intersects the side in the horizontal direction of the page.

Specifically, first, the GUI base unit 30 applies vertical direction deformation with respect to the image Tb, which is shown in FIG. 9B when each page is viewed from the front, while preventing the horizontal width from being changed as shown in FIG. 9C, and generates an image Tc in which the right side of the image Tb in FIG. 9B is shifted from the left side by S·sin θ·tan φ. Next, as shown in FIG. 9D, the GUI base unit 30 generates an image Td obtained by reducing the image Tc in FIG. 9C in the horizontal direction at a magnification of cos θ. As a result, the horizontal width of the image Td is S·cos θ. Finally, as shown in FIG. 9E, the GUI base unit 30 generates an image Te obtained by reducing the image Td in FIG. 9D in the vertical direction at a magnification of cos φ. As a result, the vertical direction dimension of the image Te becomes L·cos φ. In this way, the thumbnail image T is generated in which the page is rotated about the second virtual rotation axis M at the rotation angle θ and is further rotated about the first virtual rotation axis Q. In other words, the thumbnail image T is generated when the page is rotated about the second virtual rotation axis M at the rotation angle θ and the page is looked down at the depression angle φ from the viewpoint above the upper side of the page.

Returning to FIG. 6 again, in step S203, the image arrangement unit 36 calculates the common standard page pitch La of the dynamic portion and the static portion.

The standard page pitch La is calculated by “total occupied width*standard page pitch occupied width ratio/(the number of pages−1)”. Here, when the page pitch is a normal distribution as shown in FIG. 10A, as shown in FIG. 10B, the page pitch of the static portion becomes the standard page pitch La, and page pitches of the dynamic portion become pitches in which page pitches L1, L2, and L3 are inserted between the standard page pitch La. The total occupied width is a length Wmax obtained by adding the sum of the page pitch of the static portion and the sum of the page pitch of the dynamic portion and further adding two page pitches Lb at both ends corresponding to ½ of the “standard page width*cos(maximum rotation angle θmax)”. As shown in FIG. 10C, the standard page pitch occupied width ratio is a ratio of the length Wa of the standard page pitch occupied width excluding the page pitches L1, L2, and L3 of the dynamic portion with respect to the length Wmax of the total occupied width.

Next, in step S204, the image arrangement unit 36 calculates the spread width. Note that the spread indicates two thumbnail images T in which a predetermined position K of the dynamic portion, which is shown in FIG. 8, is sandwiched therebetween.

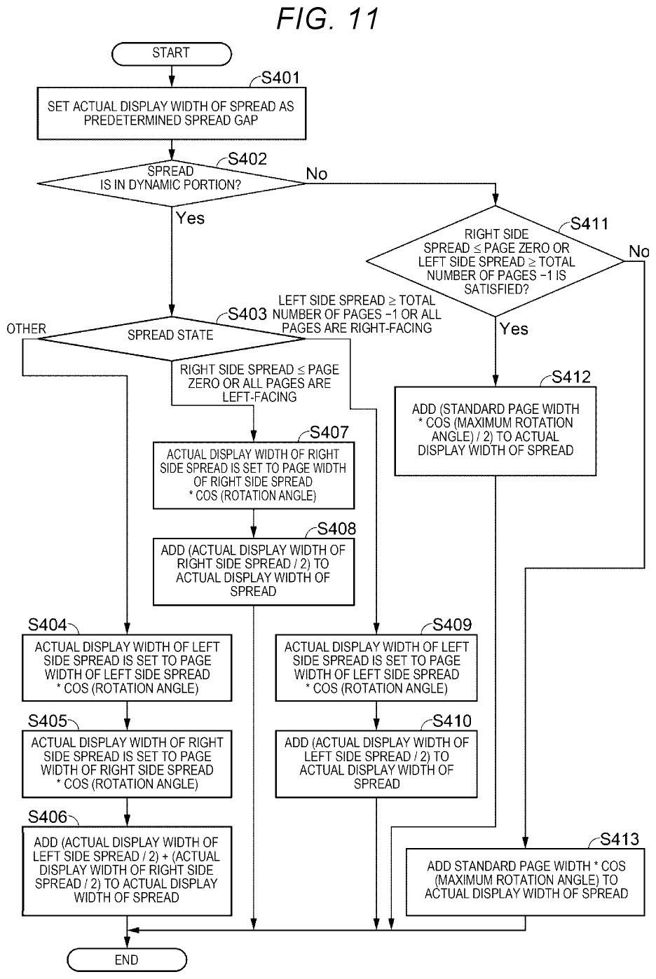

Hereinafter, the operation of calculating the spread width by the image arrangement unit 36 will be described with reference to the flowchart in FIG. 11.

First, in step S401, the image arrangement unit 36 sets an actual display width of the spread as a predetermined spread gap G. As shown in FIG. 12, the spread gap G is an interval between a left side spread page and a right side spread page.

Next, in step S402, when the spread is in the dynamic portion, “Yes” is determined and the process proceeds to step S403. Further, in step S403, when the spread state is “other” that is not “(left side spread total number of pages −1) or (all pages are right-facing)” or “(right side spread page zero) or (all pages are left-facing)”, the process proceeds to step S404 and the image arrangement unit 36 sets the actual display width of the left side spread WL to “page width of the left side spread*cos(rotation angle θ)”. Note that “all pages are right-facing” means that all pages are on the “left side spread” in FIG. 12, and “all pages are left-facing” means that all pages are on the “right side spread” in FIG. 12.

Next, in step S405, the image arrangement unit 36 sets the actual display width of the right side spread WR to “page width of the right side spread*cos (rotation angle θ)”.

Next, in step S406, the image arrangement unit 36 adds “(actual display width of the left side spread WL/2)+(actual display width of the right side spread WR/2)” to the actual display width of the spread and ends the calculation of the actual display width of the spread.

Next, the process returns to step S403, and when the spread state is “(right side spread page zero) or (all pages are left-facing)”, the process proceeds to step S407, and the actual display width of the right side spread WR is set to “page width of the right side spread*cos(rotation angle θ)”.

Next, in step S408, the image arrangement unit 36 adds “actual display width of the right side spread WR/2” to the actual display width of the spread and ends the calculation of the actual display width of the spread.

The process returns to step S403 again, and when the spread state is “(left side spread total number of pages −1) or (all pages are right-facing)”, the process proceeds to step S409, and the actual display width of the left side spread WL is set to “page width of the left side spread*cos(rotation angle θ)”.

Next, in step S410, the image arrangement unit 36 adds “actual display width of the left side spread WL/2” to the actual display width of the spread and ends the calculation of the actual display width of the spread.

Next, the process returns to step S402 and when the spread is not in the dynamic portion, “No” is determined and the process proceeds to step S411. Further, in step S411, when “(right side spread page zero) or (left side spread total number of pages −1)” is satisfied, “Yes” is determined and the process proceeds to step S412.

In step S412, the image arrangement unit 36 adds “standard page width*cos (maximum rotation angle θmax)/2” to the actual display width of the spread and ends the calculation of the actual display width of the spread.

Next, the process returns to step S411 and when “(right side spread page zero) or (left side spread the total number of pages −1)” is not satisfied, “No” is determined and the process proceeds to step S413. Further, in the step S413, the image arrangement unit 36 adds “standard page width*cos(maximum rotation angle θmax)” to the actual display width of the spread and ends the calculation of the actual display width of the spread.

Returning to FIG. 6 again, in step S205, the image arrangement unit 36 calculates a width to be shared by the pages in the dynamic portion.

The width shared by the pages in the dynamic portion is calculated by “total occupied width*(1−standard page pitch occupied width ratio)−actual display width of the spread”. The total occupied width is a length Wmax obtained by adding the total page pitch of the static portion and the total page pitch of the dynamic portion as described above, and further adding one page pitch of the static portion. The standard page pitch occupation width ratio is a ratio of the length Wa of the standard page pitch occupation width with respect to the length Wmax of the total occupation width.

Next, in step S206, the image arrangement unit 36 calculates the cumulative normal distribution of the dynamic portion.

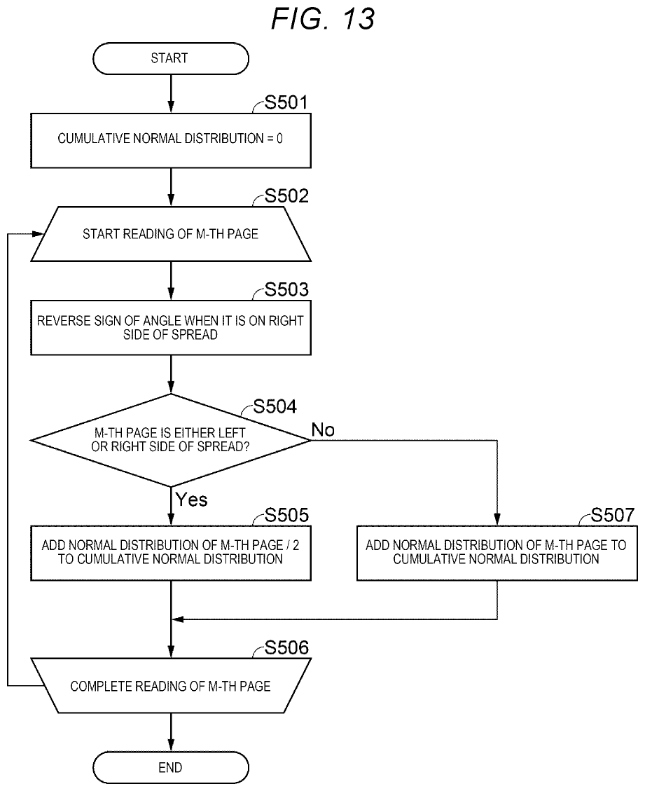

Hereinafter, the operation of calculating the cumulative normal distribution of the dynamic portion of the image arrangement unit 36 will be described with reference to the flowchart in FIG. 13.

First, in step S501, the image arrangement unit 36 sets the cumulative normal distribution to “0”.

In step S502, the image arrangement unit 36 starts reading the M-th page of the dynamic portion. M is an integer of 1 or more.

Next, in step S503, the image arrangement unit 36 reverses the sign of angle of the rotation angle θ when it is on the right side of the spread.

Next, in step S504, when the M-th page is either left or right side of the spread, “Yes” is determined and the process proceeds to step S505. Further, in step S505, the image arrangement unit 36 adds “normal distribution of the M-th page/2” to the cumulative normal distribution.

Next, in step S506, the image arrangement unit 36 completes reading the M-th page and ends the calculation of the cumulative normal distribution.

The process returns to step S504 and when the M-th page is not either left or right side of the spread, “No” is determined and the process proceeds to step S507. Further, in step S507, the image arrangement unit 36 adds “normal distribution of the M-th page” to the cumulative normal distribution.

Next, in step S506, the process returns to step S502, the operations from step S502 to step S506 are repeated for the number of pages, and the image arrangement unit 36 completes the reading of the M-th page and ends the calculation of the cumulative normal distribution.

By calculating the cumulative normal distribution as described above, it is possible to calculate an arrangement having a spread in the dynamic portion as shown in FIG. 14.

Returning to FIG. 6 again, in step S207, the image arrangement unit 36 arranges the thumbnail images T of each page and generates a thumbnail image bundle G.

Hereinafter, the operation of arranging each page by the image arrangement unit 36 will be described with reference to the flowchart in FIG. 15.

First, in step S601, the image arrangement unit 36 sets an X coordinate of the page zero to “standard page width La*cos(maximum rotation angle θmax)/2”. The X coordinate is a length in the X-axis direction which is the horizontal direction from a left side end portion, when the left side end portion of both end portions facing in the horizontal direction of the first page, is set to “0”.

Next, in step S602, the image arrangement unit 36 starts reading the N-th page of the original image. N is an integer of 1 or more.

Next, in step S603, when the N-th page is on the right of the spread, “Yes” is determined and the process proceeds to step S604, and in the step S604, when the N-th page is in the dynamic portion, “Yes” is determined and the process proceeds to step S605.

Next, in step S605, the image arrangement unit 36 adds “width shared in the dynamic portion*normal distribution of the N-th page/cumulative normal distribution/2” to the X coordinate.

Next, in step S606, the image arrangement unit 36 sets the X coordinate of the N-th page as the X coordinate.

Next, in step S607, when the N-th page is on the right side spread, “Yes” is determined and the process proceeds to step S608. When the N-th page is not on the right side spread, “No” is determined and the process proceeds to step S614. Further, in step S614, the image arrangement unit 36 adds “width shared in the dynamic portion*normal distribution of the N-th page/2” to the X coordinate and the process proceeds to step S608.

Next, the process returns to step S604 and when the N-th page is not in the dynamic portion, “No” is determined, and in step S613, the X coordinate of the N-th page is set as the X coordinate, and the process proceeds to step S608.

Next, the process returns to step S603 and when the N-th page is not on the right side spread, “No” is determined and the process proceeds to step S611, and in step S611, the actual display width of the spread is added to the X coordinate.

Next, in step S612, the X coordinate of the N-th page is set as the X coordinate, and the process proceeds to step S608.

Next, in step S608, the standard page pitch La is added to the X coordinate. In step S609, the process returns to step S602, the operations from step S602 to step S609 are repeated for the number of pages, and the image arrangement unit 36 completes the reading of the N-th page and ends the calculation of the X coordinate of each page.

Thereafter, based on the X coordinate of each page calculated by the image arrangement unit 36, the thumbnail image T generated by the GUI base unit 30 is arranged on the first virtual rotation axis Q, and the generation of the thumbnail image bundle G is ended.

Returning to FIG. 5, in step S105, the control unit 3 displays the thumbnail image bundle G, which is configured with the thumbnail images T generated in step S104, on the image display unit 2.

Through the above flow, the thumbnail image bundle G arranged in the ascending order of the page numbers from the right side to the left side along the horizontal direction of the image display unit 2 is displayed on the image display unit 2.

The various calculation values calculated in each step are stored in the RAM 5 for each page, and are read from the RAM 5 and used for various calculations whenever necessary for the calculation.

According to the viewer 10 as the display apparatus or the display method as described above, since the thumbnail image T arranged in the static portion is displayed by being partially overlapped with the adjacent thumbnail image T, a part of the description content of the thumbnail image T can be checked. Further, since the thumbnail image T arranged in the dynamic portion is displayed so that the rotation angle θ about the second virtual rotation axis M is reduced as the thumbnail image T is closer to the predetermined position K. Accordingly, the image width becomes wider as the thumbnail image T is closer to the predetermined position K and it becomes easier to check the description content of the thumbnail image T. Therefore, it is possible to check the description contents of all the thumbnail images T at once.

Further, since the predetermined position K is in the center of the dynamic portion in the horizontal direction in which the plurality of thumbnail images T are arranged, thumbnail images T having a wide image width are arranged on both sides of the predetermined position K, and it becomes easier to check the description contents of the thumbnail images T arranged in the dynamic portion.

Next, Display Examples 1 to 9 will be described regarding a display method when a user performs a predetermined operation using the buttons 7A to 7F or the touch panel 7G of the input unit 7, or a display method programmed beforehand other than the program which controls the control unit 3 described above.

### DISPLAY EXAMPLE 1

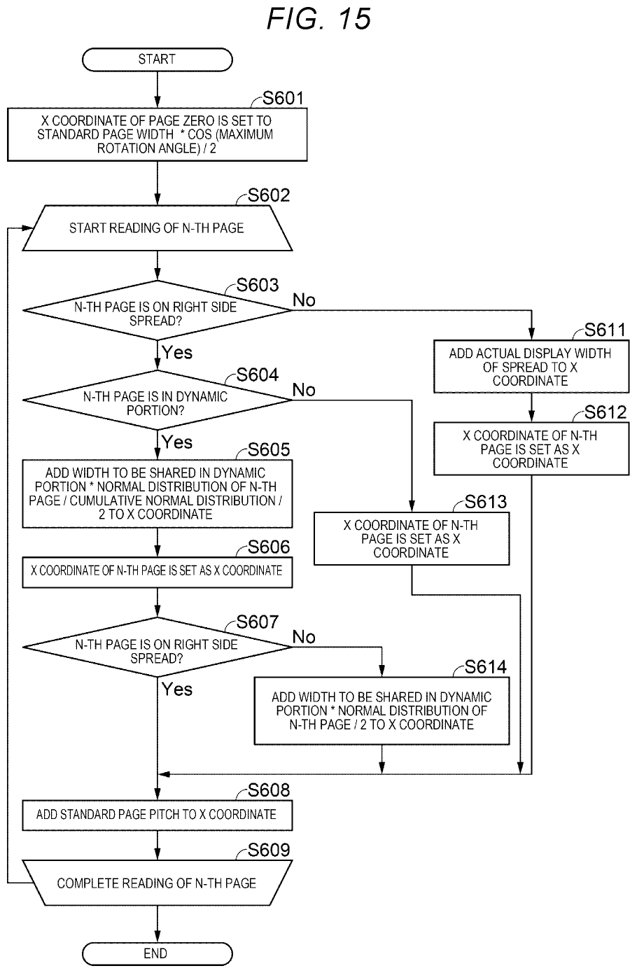

A display method for enlarging and displaying an image bundle will be described with reference to FIG. 16.

FIG. 16 is a diagram in which a thumbnail image bundle is enlarged and displayed. Note that configuration parts in the viewer 10 will be described with the same reference numerals as described above.

As shown in FIG. 16, when a user moves the thumbnail image bundle G upward with a finger as indicated by an arrow A1, and releases the finger from the touch panel 7G, the control unit 3 performs a process of enlarging the thumbnail image bundle G at a predetermined enlargement ratio and displaying the enlarged thumbnail image bundle G near the position where the thumbnail image bundle G is moved with the finger in the image display unit 2. Further, the enlarged thumbnail image bundle G is displayed as the thumbnail image bundle G of the original size when the user moves the finger downward and releases the finger from the touch panel 7G.

Note that the enlarged thumbnail image bundle G has the same length as the original thumbnail image bundle G in the horizontal direction that is the width direction, and each thumbnail image T is enlarged and displayed at a predetermined enlargement ratio.

According to this display method, it is possible to easily recognize the description content of each thumbnail image T in the thumbnail image bundle G by enlarging and displaying the thumbnail image bundle G at a predetermined enlargement ratio.

### DISPLAY EXAMPLE 2

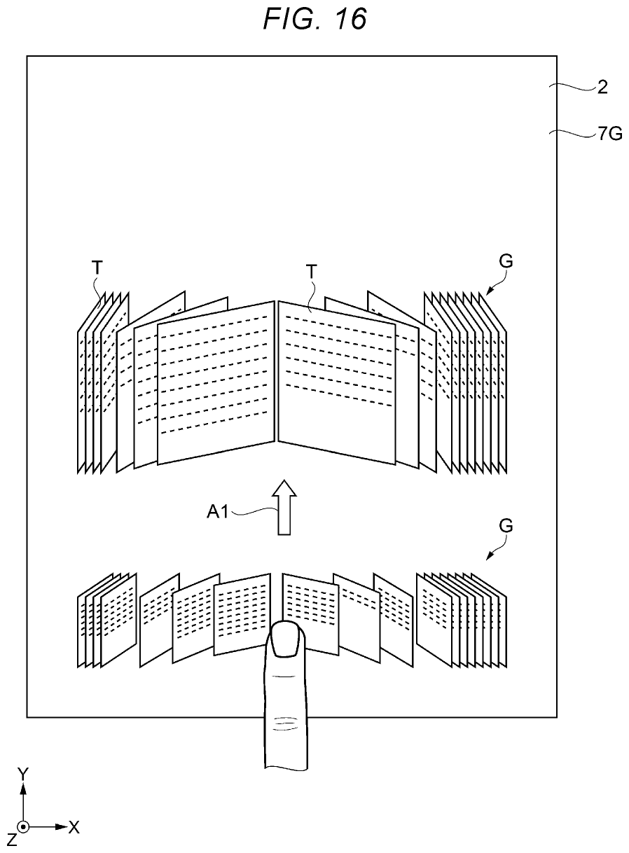

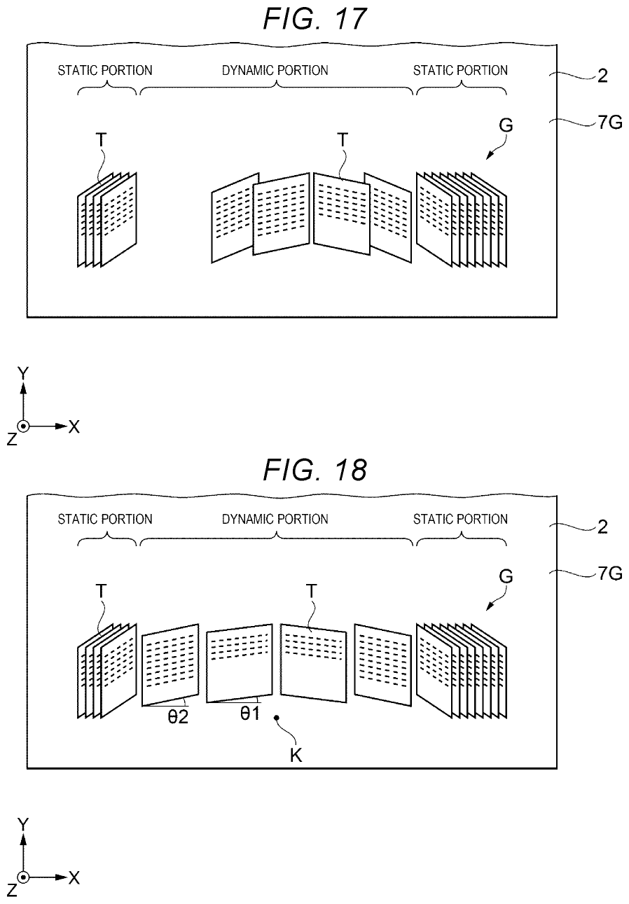

A display method for displaying an image bundle in which the number of images in the dynamic portion is less than a predetermined number of images will be described with reference to FIG. 17.

FIG. 17 is a diagram in which a thumbnail image bundle, where the number of images in the dynamic portion is less than a predetermined number of images, is displayed. Note that configuration parts in the viewer 10 will be described with the same reference numerals as described above.

As shown in FIG. 17, when the number of images in the dynamic portion is less than a predetermined number of images, for example, when the predetermined number of images in the dynamic portion is six and the number of images in the dynamic portion is four, the control unit 3 calculates an arrangement, in which two fictitious images are added to the left side of four existing images, and displays the four thumbnail images T on the right side in the dynamic portion as shown in FIG. 17.

According to this display method, continuous images are displayed at a concentrated position without being distantly arranged with a small number of images, so that the appearance becomes beautiful.

### DISPLAY EXAMPLE 3

Another display method for displaying an image bundle in which the number of images in the dynamic portion is less than a predetermined number of images will be described with reference to FIG. 18.

FIG. 18 is a diagram in which a thumbnail image bundle, where the number of images in the dynamic portion is less than a predetermined number of images, is displayed. Note that configuration parts in the viewer 10 will be described with the same reference numerals as described above.

As shown in FIG. 18, when the number of images of the dynamic portion is less than a predetermined number of images, the control unit 3 performs a process of displaying the rotation angle θ of the thumbnail image T arranged in the dynamic portion with a smaller angle as compared with a case where the predetermined number of images are arranged in the dynamic portion when a user touches the thumbnail image T in the dynamic portion with a finger. Specifically, when the number of images in the dynamic portion is less than a predetermined number of images, a rotation angle θ1 of a thumbnail image T closest to a predetermined position K is made smaller than a rotation angle θ1 of a thumbnail image T closest to the predetermined position K when the predetermined number of images are arranged in the dynamic portion. Further, a rotation angle θ2 of a thumbnail image T second closest to the predetermined position K is made smaller than a rotation angle θ2 of a thumbnail image T second closest to the predetermined position K when a predetermined number of images are arranged in the dynamic portion.

When the number of images in the dynamic portion is less than a predetermined number of images, a program may be automatically controlled so as to reduce the rotation angle θ of the thumbnail image T arranged in the dynamic portion as compared with a case where the predetermined number of images are arranged in the dynamic portion.

According to this display method, by displaying the thumbnail image T in the dynamic portion with a smaller rotation angle θ about the second virtual rotation axis M, an image width of the thumbnail image T arranged in the dynamic portion becomes wider, and it becomes easier to check the description content of the thumbnail image T arranged in the dynamic portion.

### DISPLAY EXAMPLE 4

A display method for displaying an image bundle in which a vertically long image and a horizontally long image are mixed will be described with reference to FIG. 19.

FIG. 19 is a diagram in which a thumbnail image bundle, where a vertically long image and a horizontally long image are mixed, is displayed. Configuration parts in the viewer 10 will be described with the same reference numerals as described above.

As shown in FIG. 19, in the thumbnail image bundle G in which a vertically long thumbnail image T, where a length in the horizontal direction is shorter as compared to a length in the vertical direction, and a horizontally long thumbnail image TW, where a length in the horizontal direction is longer as compared to a length in the vertical direction, are mixed in the dynamic portion, when the number of horizontally long thumbnail images TW is greater than the number of vertically long thumbnail images T in the dynamic portion, the control unit 3 performs a process of displaying a reduced number of images as compared with the number of images when the number of horizontally long thumbnail images TW is less than the number of vertically long thumbnail images T.

According to this display method, when the number of horizontally long thumbnail images TW is greater than the number of vertically long thumbnail images T in the dynamic portion, by reducing the number of images in the dynamic portion and displaying, an interval between the horizontally long thumbnail image TW and the adjacent image becomes wider, and an overlapping area becomes smaller so that it is easier to check the description content of the horizontally long thumbnail image TW.

### DISPLAY EXAMPLE 5

A display method for aligning and displaying the end portions of each image of an image bundle in which a vertically long image and a horizontally long image are mixed will be described with reference to FIG. 20.

FIG. 20 is a diagram in which a thumbnail image bundle where a vertically long image and a horizontally long image are mixed, and an end portion of each thumbnail image is aligned and displayed. Configuration parts in the viewer 10 will be described with the same reference numerals as described above.

In the thumbnail image bundle G in which a vertically long thumbnail image T and a horizontally long thumbnail image TW are mixed, each of the thumbnail images T and TW is displayed with the center aligned in the vertical direction. Therefore, when a user touches a thumbnail image bundle G with a finger and moves the thumbnail image bundle G upward or downward, and a part of the upper end or the lower end of the thumbnail image bundle G is not displayed on the image display unit 2, the control unit 3 performs a process of aligning and displaying either one of end portions among the both end portions, that face each other, of the thumbnail images T and TW in the vertical direction. Specifically, as shown in FIG. 20, only the upper part of the thumbnail image bundle G that is a predetermined range of the thumbnail image bundle G is displayed, that is, when the lower ends of the thumbnail images T and TW are not displayed on the image display unit 2, a thumbnail image bundle G, in which the upper end portion of each of the thumbnail images T and TW is aligned, is displayed. Further, only the lower part of the thumbnail image bundle G that is a predetermined range of the thumbnail image bundle G is displayed, that is, when the upper ends of the thumbnail images T and TW are not displayed on the image display unit 2, a thumbnail image bundle G, in which the lower end portion of each of the thumbnail images T and TW is aligned, is displayed.

According to this display method, even when a plurality of thumbnail images T and TW constituting the thumbnail image bundle G include a vertically long thumbnail image T and a horizontally long thumbnail image TW together or when one of the both end portions of the plurality of thumbnail images T and TW facing each other in the vertical direction is not displayed, it is possible to check the description content of the horizontally long thumbnail image TW by aligning and displaying either one of end portions among the both end portions, that face each other, of the plurality of thumbnail images T and TW constituting the thumbnail image bundle G in the vertical direction.

### DISPLAY EXAMPLE 6

A display method in which an interval between an operation image and the adjacent image is widened and displayed will be described with reference to FIG. 21.

FIG. 21 is a diagram in which an interval between an operating thumbnail image and an adjacent thumbnail image is widened and displayed. Configuration parts in the viewer 10 will be described with the same reference numerals as described above.

As shown in FIG. 21, when a predetermined operation such as a user touching the operating thumbnail image TS as an operation image with a finger is performed, the control unit 3 performs a process in which an interval between the operating thumbnail image TS and the thumbnail image T adjacent to each other is widened and displayed. Specifically, each of an interval W1 between the operating thumbnail image TS and a thumbnail image T on the left side of the operating thumbnail image TS, and an interval W2 between the operating thumbnail image TS and a thumbnail image T on the right side of the operating thumbnail image TS is displayed wider than an interval before a predetermined operation in which the operating thumbnail image TS is touched with a finger.

According to this display method, since the interval between the operating thumbnail image TS and the adjacent thumbnail image T is displayed wider, an area overlapping the operating thumbnail image TS and the adjacent thumbnail image T is reduced, and it becomes easy to check the description content of the thumbnail image T adjacent to the operating thumbnail image TS.

### DISPLAY EXAMPLE 7

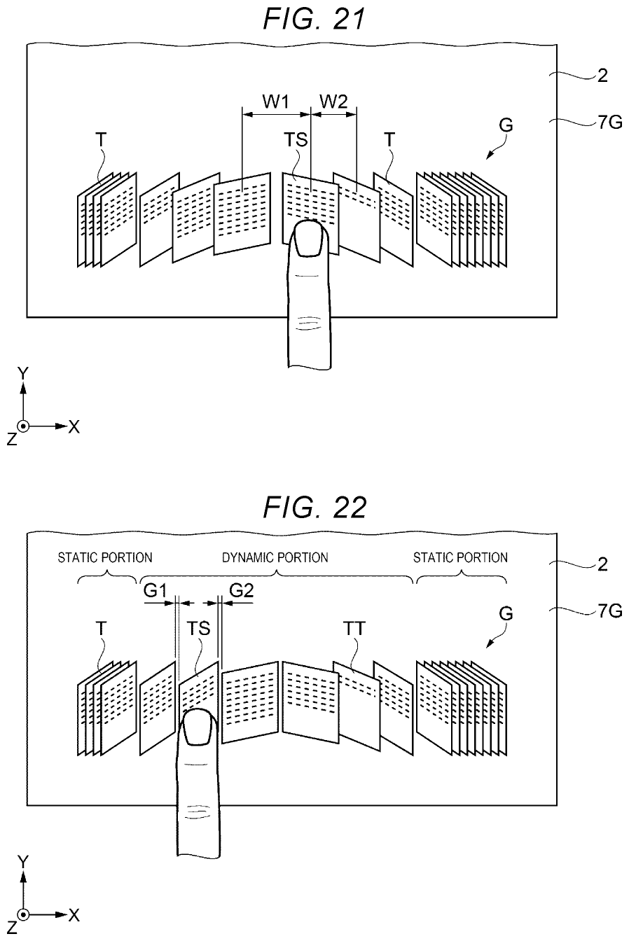

A display method for displaying an operation image and an adjacent image so as not to overlap with each other, will be described with reference to FIG. 22.

FIG. 22 is a diagram in which an operating thumbnail image and an adjacent thumbnail image are displayed so as not to overlap with each other. Configuration parts in the viewer 10 will be described with the same reference numerals as described above.

As shown in FIG. 22, when a predetermined operation such as a user touching the operating thumbnail image TS as an operation image that is arranged in the dynamic portion with a finger for a predetermined time or longer, for example, one second or longer, is performed, the control unit 3 performs a process of displaying the operating thumbnail image TS and the adjacent thumbnail image T so as not to overlap with each other. Specifically, an interval G1 between the operating thumbnail image TS and a thumbnail image T on the left side of the operating thumbnail image TS, and an interval G2 between the operating thumbnail image TS and a thumbnail image T on the right side of the operating thumbnail image TS are provided and displayed.

According to this display method, by displaying the operating thumbnail image TS arranged in the dynamic portion and the adjacent thumbnail image T so as not to overlap with each other, it is possible to easily check the described content of the thumbnail image T adjacent to the operating thumbnail image TS.

### DISPLAY EXAMPLE 8

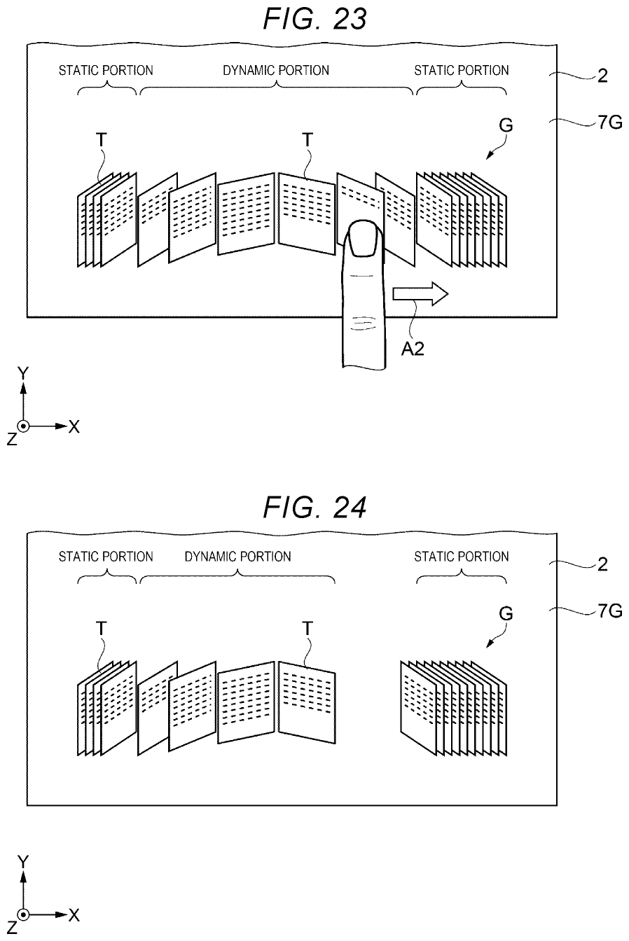

A display method for moving and displaying an image in a dynamic portion to a static portion will be described with reference to FIGS. 23 and 24.

FIG. 23 is a diagram for explaining a method for moving and displaying a thumbnail image in a dynamic portion to a static portion, and FIG. 24 is a diagram in which the thumbnail image in the dynamic portion is moved to the static portion and displayed. Configuration parts in the viewer 10 will be described with the same reference numerals as described above.

As shown in FIG. 23, when a user touches a thumbnail image T arranged in the dynamic portion with a finger and moves the thumbnail image T to the right side as indicated by an arrow A2, the control unit 3 performs a process of moving a thumbnail image T touched with a finger and a thumbnail image T arranged between the thumbnail image T touched with the finger and the static portion to the static portion, and performs a process of arranging and displaying the moved thumbnail images T in the static portion as shown in FIG. 24. That is, the thumbnail image T displayed in the dynamic portion can be moved to the static portion. Note that, the thumbnail image T displayed in the static portion can be moved to the dynamic portion. Specifically, it can be displayed by touching the thumbnail image T in the static portion with a finger and moving the thumbnail image T to the dynamic portion.

According to this display method, the number of thumbnail images T arranged in the dynamic portion can be reduced, and the thumbnail images T arranged in the dynamic portion can be seen more easily.

### DISPLAY EXAMPLE 9

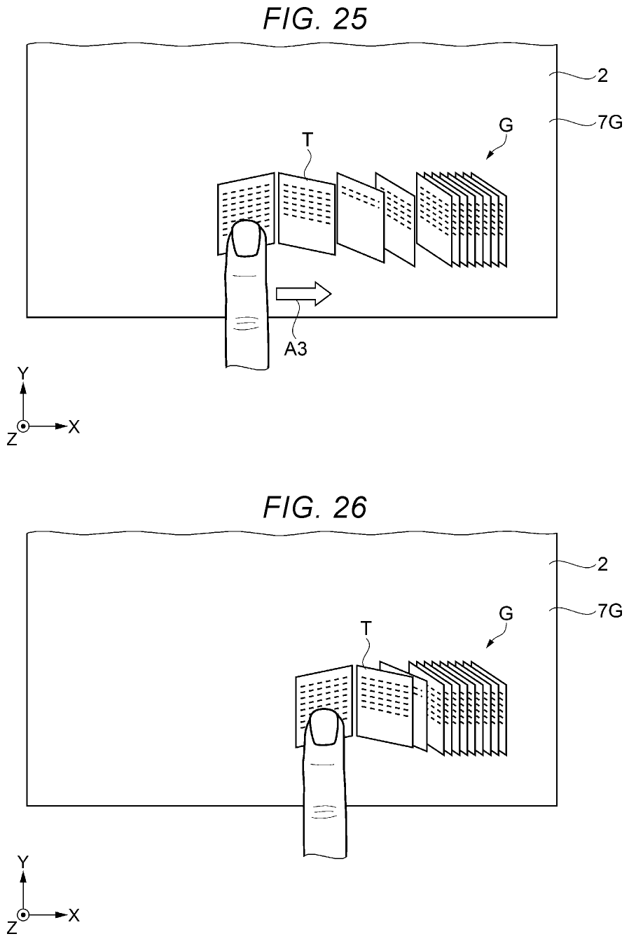

A display method for reducing and displaying the width of an image bundle will be described with reference to FIGS. 25 and 26.

FIGS. 25 and 26 are diagrams for explaining a method for reducing and displaying the width of a thumbnail image bundle. Configuration parts in the viewer 10 will be described with the same reference numerals as described above.

As shown in FIG. 25, when a user touches the thumbnail image T arranged on the leftmost side of the thumbnail image bundle G with a finger and moves the thumbnail image T to the right side as indicated by an arrow A3, the control unit 3 performs a process of displaying the thumbnail image bundle G as shown in FIG. 26 by reducing a length of the thumbnail image bundle G in the horizontal direction, which is the width direction. When the finger is released from the touch panel 7G, the thumbnail image bundle G having the original width is displayed. Note that the thumbnail image bundle G can be moved and reduced to the left side and displayed.

According to this display method, when the thumbnail image bundle G is displayed so as to overlap the enlarged thumbnail image T or another thumbnail image bundle G or the like, by reducing and displaying the width of the thumbnail image bundle G, it is possible to easily check the described content of the enlarged thumbnail image T and thumbnail image bundle G that overlapped the thumbnail image bundle G.

Hereinafter, the content derived from the above-described embodiment will be described.

Provided is a display method in which each of a plurality of images arranged on a first virtual axis is displayed on a display unit by being rotated about each of second virtual axes intersecting the first virtual axis, and further rotated about the first virtual axis, in which an image bundle formed by the plurality of images that are arranged along a first direction has a static portion in which the images are arranged at equal intervals in a state where apart of the image is displayed by being overlapped with an adjacent image, and a dynamic portion in which an interval between the images adjacent to each other is arranged wider than an interval between the images in the static portion, the image displayed in the dynamic portion is movable to the static portion, and a rotation angle of the image in the dynamic portion about the second virtual axis along the second direction intersecting the first direction becomes smaller as the image in the dynamic portion is closer to a predetermined position.

According to this display method, the image arranged in the static portion is displayed so as to partially overlap the adjacent image, so that a part of the description content of the image can be checked. Further, since the image arranged in the dynamic portion is displayed so that the rotation angle about the second virtual axis is smaller as the image is closer to the predetermined position, the image width becomes wider when the image is closer to the predetermined position, so it becomes easier to confirm the description of the image. Therefore, it is possible to check the description contents of all the images at once.

In the display method described above, the predetermined position may be a center of the dynamic portion in the first direction.

According to this display method, since the predetermined position is in the center of the dynamic portion in the first direction in which the plurality of images are arranged, images having a wide image width are arranged on both sides of the predetermined position, and it becomes easier to check the description contents of the images arranged in the dynamic portion.

In the display method described above, when the image bundle is moved in the second direction, the image bundle may be enlarged and displayed at a predetermined enlargement ratio.

According to this display method, it is possible to easily recognize the description content of each image in the image bundle by enlarging and displaying the image bundle at a predetermined enlargement ratio.

In the display method described above, when the number of the plurality of images in the dynamic portion is less than a predetermined number of images, the rotation angles of the plurality of images in the dynamic portion may be displayed smaller than the case of the predetermined number of images.

According to this display method, by displaying the image in the dynamic portion with a smaller rotation angle about the second virtual axis, an image width of the image arranged in the dynamic portion becomes wider, and it becomes easier to check the description content of the image arranged in the dynamic portion.

In the display method described above, in a case where the number of images, in which a length in the first direction is longer as compared with a length in the second direction, is greater than the number of images, in which the length in the first direction is shorter as compared with the length in the second direction in the dynamic portion, the number of images in the dynamic portion may be reduced and displayed as compared with a case where the number of images, in which the length in the first direction is shorter as compared with the length in the second direction, is greater than the number of images, in which the length in the first direction is longer as compared with the length in the second direction.

According to this display method, when the number of vertically long images, in which a length in the first direction is shorter as compared with a length in the second direction, is greater than the number of horizontally long images, in which the length in the first direction is longer as compared with the length in the second direction in the dynamic portion, since an interval between the horizontally long image and the adjacent image becomes wider and the overlapping area becomes smaller by reducing and displaying the number of images in the dynamic portion, it becomes easier to check the description content of the horizontally long image arranged in the dynamic portion.

In the display method described above, when a part of the image bundle is not displayed, either one of end portions among the both end portions, that face each other, of each of the plurality of images constituting the image bundle in the second direction, may be aligned and displayed.

According to this display method, even when a vertically long image and a horizontally long image are mixed in the plurality of images constituting the image bundle and one of the both end portions, that face each other, of the plurality of images in the second direction is not displayed, the description content of the horizontally long image can be checked by aligning and displaying either one of end portions among the both end portions, that face each other, of the plurality of images constituting the image bundle in the second direction.

In the display method described above, an interval between an operation image, in which a predetermined operation is performed in the image bundle, and the adjacent image may be displayed wider than before the predetermined operation.

According to this display method, since the interval between the operation image and the adjacent image is displayed wider, the area where the operation image and the adjacent image overlap is reduced, and it becomes easy to check the description content of the image adjacent to the operation image.

In the display method described above, when an operation image, in which a predetermined operation is performed in the image bundle, is arranged in the dynamic portion, the images adjacent to each other may be displayed so as not to overlap with each other.

According to this display method, since the operation image arranged in the dynamic portion and the adjacent image are displayed so as not to overlap with each other, the description content of the image adjacent to the operation image can be easily checked.

Provided is a display apparatus including: a display unit that displays an image bundle formed by a plurality of images arranged along a first direction; an image generation unit that generates the plurality of images in which each of the plurality of images arranged on a first virtual axis along the first direction are rotated about each of the second virtual axes intersecting the first virtual axis, and further rotated about the first virtual axis; and a control unit that displays the image bundle having a static portion in which the images are arranged at equal intervals in a state where a part of the image is displayed by being overlapped with an adjacent image, and a dynamic portion in which an interval between the images adjacent to each other is arranged wider than an interval between the images in the static portion, and displays a rotation angle of the image in the dynamic portion about the second virtual axis along a second direction intersecting the first direction smaller as the image in the dynamic portion is closer to a predetermined position.

According to this display apparatus, the image arranged in the static portion is displayed so as to partially overlap the adjacent image, so that a part of the description content of the image can be checked. Further, since the image arranged in the dynamic portion is displayed so that the rotation angle about the second virtual axis is smaller as the image is closer to the predetermined position, the image width becomes wider when the image is closer to the predetermined position, so it becomes easier to confirm the description of the image. Therefore, it is possible to check the description contents of all the images at once.

What is claimed is:

1. A display method in which each of a plurality of images arranged on a first virtual axis is displayed on a display unit by being rotated about each of second virtual axes intersecting the first virtual axis, and further rotated about the first virtual axis, wherein
an image bundle formed by the plurality of images that are arranged along a first direction has
a static portion in which the images are arranged at equal intervals in a state where a part of the image is displayed by being overlapped with an adjacent image, and
a dynamic portion in which an interval between the images adjacent to each other is arranged wider than an interval between the images in the static portion,
the image displayed in the dynamic portion is movable to the static portion, and
a rotation angle of the image in the dynamic portion about the second virtual axis along the second direction intersecting the first direction becomes smaller as the image in the dynamic portion is closer to a predetermined position.

2. The display method according to claim 1, wherein
the predetermined position is a center of the dynamic portion in the first direction.

3. The display method according to claim 1, wherein
when the image bundle is moved in the second direction, the image bundle is enlarged and displayed at a predetermined enlargement ratio.

4. The display method according to claim 1, wherein
when the number of the plurality of images in the dynamic portion is less than a predetermined number of images, the plurality of images in the dynamic portion are displayed with the rotation angles smaller than a case of the predetermined number of images.

5. The display method according to claim 1, wherein
when the number of images, in which a length in the first direction is longer as compared with a length in the second direction, is greater than the number of images, in which the length in the first direction is shorter as compared with the length in the second direction in the dynamic portion,
the plurality of images in the dynamic portion are displayed with the number of images in the dynamic portion reduced as compared with a case where the number of images, in which the length in the first direction is shorter as compared with the length in the second direction, is greater than the number of images, in which the length in the first direction is longer as compared with the length in the second direction.

6. The display method according to claim 1, wherein
when a part of the image bundle is not displayed, either one of both end portions, that face each other in the second direction, of each of the plurality of images forming the image bundle, is aligned and displayed.

7. The display method according to claim 1, wherein
an interval between an operation image, in which a predetermined operation is performed in the image bundle, and the adjacent image is displayed wider than before the predetermined operation.

8. The display method according to claim 1, wherein
when an operation image, in which a predetermined operation is performed in the image bundle, is arranged in the dynamic portion, the images adjacent to each other are displayed so as not to overlap with each other.

9. A display apparatus comprising:
a display unit that displays an image bundle formed by a plurality of images arranged along a first direction;
an image generation unit that generates the plurality of images in which each of the plurality of images arranged on a first virtual axis along the first direction are rotated about each of second virtual axes intersecting the first virtual axis, and further rotated about the first virtual axis; and
a control unit that
displays the image bundle having
a static portion in which the images are arranged at equal intervals in a state where a part of the image is displayed by being overlapped with an adjacent image, and
a dynamic portion in which an interval between the images adjacent to each other is arranged wider than an interval between the images in the static portion,
displays the image in the dynamic portion such that the image in the dynamic portion closer to a predetermined position has a smaller rotation angle about the second virtual axis along a second direction intersecting the first direction.
